(19) United States
(12) Patent Application Publication
(10) Pub. No.: US 2020/0398947 A1
(43) Pub. Date: Dec. 24, 2020

(54) Offshore Electric Power Generating System

(71) Applicant: Eldon Scott Hulsey, Henderson, TX (US)

(72) Inventor: Eldon Scott Hulsey, Henderson, TX (US)

(21) Appl. No.: 16/447,467

(22) Filed: Jun. 20, 2019

(51) Int. Cl. B63B 35/44; F03B 13/10; F03B 17/06

(52) U.S. Cl. CPC B63B 35/44; B63B 2035/4466; F03B 17/061; F03B 13/10

(57) ABSTRACT

A mobile offshore electric power system used for generating electricity from an ocean current or a navigable river current. The offshore electric power system uses a platform from a decommissioned oil drilling rig to suspend one, two or more hydro-kinetic turbines, with electric generators, in the ocean current. The electric generators are connected to an electric generator cable to the platform and then transferred to an onshore electric cable connected to a power grid. The platform can be from a converted semi-submersible drilling rig, which is anchored to an ocean floor. Also, the platform can be from a jack-up drilling rig. Further, the platform can be mounted on a large ocean-going boat, with a dynamic positioning system, used in a navigable river.

### BACKGROUND OF THE INVENTION

### (a) Field of the Invention

This invention relates to an electric power generating system and more particularly, but not by way of limitation, to a mobile offshore electric power unit used for generating electricity using an ocean current or a navigable river current.

### (b) Discussion of Prior Art

Heretofore, it is well known that others have tried to harnessing power from rivers, waves, tides and, in particular, ocean currents to generate electricity. Also, it is well known that the Gulf Stream, from the Florida Keys to North Carolina, flows at a rate of approximately 5 knots and is over 60 miles wide. The volumetric rate of the Gulf Stream is estimated at 150 Sverdrups (1 Sverdrup equals 1,000,000 meters per second). The combined flow rate of rivers is estimated at 0.6 Sverdrups. The energy capacity factor of an ocean current is extremely high, such that a 5 knot current is equivalent to a 100 mile wind. The Gulf Stream and other currents, unlike tides and waves, is continuous and dependable due to the Coriolis Affect caused by the Earth's rotation. The subject invention taps into the dependability of the Coriolis Affect.

In U.S. Pat. No. 9,334,849 to Dehlsen, U.S. Pat. No. 5,230,215 to Nagata, U.S. Pat. No. 7,279,803 to Bosley, and U.S. Patent Application Publications 2002/0158472 to Robson, 2010/0230971 to Mackie, and 2007/0231072 to Jennings et al. various ocean current power generating systems, turbines, and plants are disclosed. None of these prior art references disclose the unique features, objects and advantages of the subject offshore electric power generating system as described herein.

### SUMMARY OF THE INVENTION

In view of the foregoing, it is a primary objective of the subject invention to provide an offshore electric power system for generating low cost electricity from an ocean current or river current.

Another object of the invention is the electricity generated from the system can be transferred to a nearby onshore electrical grid system for public use or stored in large storage batteries, on a container ship, for transfer to an onshore location.

Yet another object of the power system is two different types of decommissioned oil drilling rigs can be converted to an ocean platform, at a low cost, for suspending one or more large hydro-kinetic turbines in an ocean current for generating electric power.

The subject invention includes an offshore electric power system using a platform from a decommissioned oil drilling rig to suspend one, two or more hydrokinetic turbines, with electric generators, in the ocean current. The electric generators are connected to an electric cable to the platform and then transferred to a onshore electric cable connected to a power grid. The platform can be from a converted semi-submersible drilling rig, which is anchored to an ocean floor. Also, the platform can be from a jack-up drilling rig. Further, the platform can be mounted on a large ocean-going boat, with a dynamic positioning system, used in a navigable river.

These and other objects of the present invention will become apparent to those familiar with electric power generating systems when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the subject power generating system, and in which:

FIG. 1 is a perspective view of a decommissioned semi-submersible oil drilling rig anchored to an ocean floor and illustrating a pair of hydro-kinetic turbines suspended in an ocean current. FIG. 1 illustrates a first embodiment of the subject invention.

FIG. 2 is a perspective view of a decommissioned jack up oil drilling rig anchored to an ocean floor and illustrating a pair of hydro-kinetic turbines suspended in an ocean current. FIG. 2 illustrates a second embodiment of the subject invention.

FIG. 3 is a perspective view of an ocean going boat with platform and illustrating a pair of hydro-kinetic turbines suspended in a navigable river current. FIG. 3 illustrates a third embodiment of the subject invention.

FIG. 4 is a perspective view of the ocean going boat, shown in FIG. 3, illustrating a dynamic positioning system for keeping the boat and the hydro-kinetic turbines oriented with the flow of the river current.

FIG. 5 is a perspective view of a control station on the ocean going boat and used with the dynamic positioning system shown in FIG. 4.

### DETAILED DESCRIPTION OF THE PREFERRED EMBODIMENTS

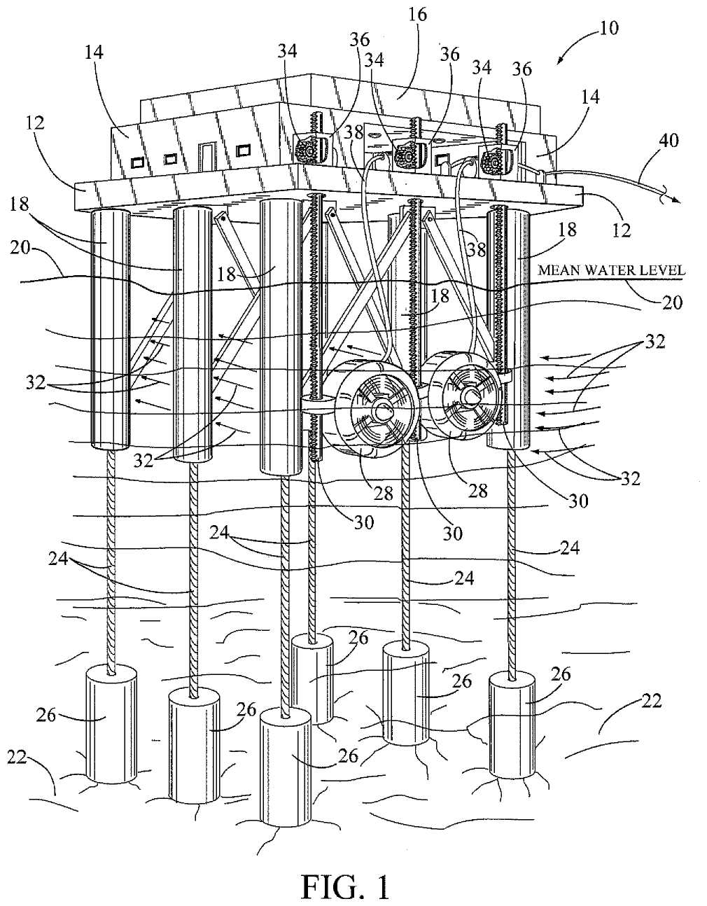

In FIG. 1, a perspective view of a decommissioned semi-submersible oil drilling rig is shown, having a general reference numeral 10. The drilling rig includes an operating platform deck 12, with a maintenance shop 14 and platform offices 16. The offices 16 can include a control room, a dining hall, living quarters, and the like. The drilling rig equipment, used for offshore oil well drilling, has been removed from the deck 12.

Extending downwardly from the sides of the deck 12 are buoyant columns 18 for holding the deck above a mean water level 20, in a range of 60 to 80 feet. Typically, the columns 18 extend below the water level 20, a distance in a range of 120 to 160 feet. The columns 18 are anchored, for stability, to an ocean floor 22 using a chain or a rope mooring line 24, having a diameter in a range of 6 to 8 inches. An upper end of the mooring line 24 is attached to a bottom of the columns 18. A lower end of the mooring line 24 is attached to a top of suction pylons 26, set in the ocean floor 22.

In this drawing, a pair of hydro-kinetic turbines 28 are shown suspended into the ocean vertically and attached to three pinion gear racks 30. The turbines 28, which include electric generators, not shown in the drawings, are positioned to face the incoming ocean current, shown as arrows 32. Mounted on the deck 12 are three pinion gears 34 disposed inside gear housings 36. The gears 34 are used to raise and lower the gear racks 30 and the attached turbines 28 in the ocean current 32 to obtain a maximum current flow for generating electricity in the turbine generators. The electric current is sent, via electric generator cables 38, to the deck 12. The electricity is than transferred to an electric land transmission cable 40, which extends to a nearby ocean shore and then to an electrical power grid system. While the pinion gear racks 30 and pinion gears 34 are shown in the drawings for raising and lowering the turbines 28, it should be kept in mind other means for raising and lowering the turbines could be used equally well.

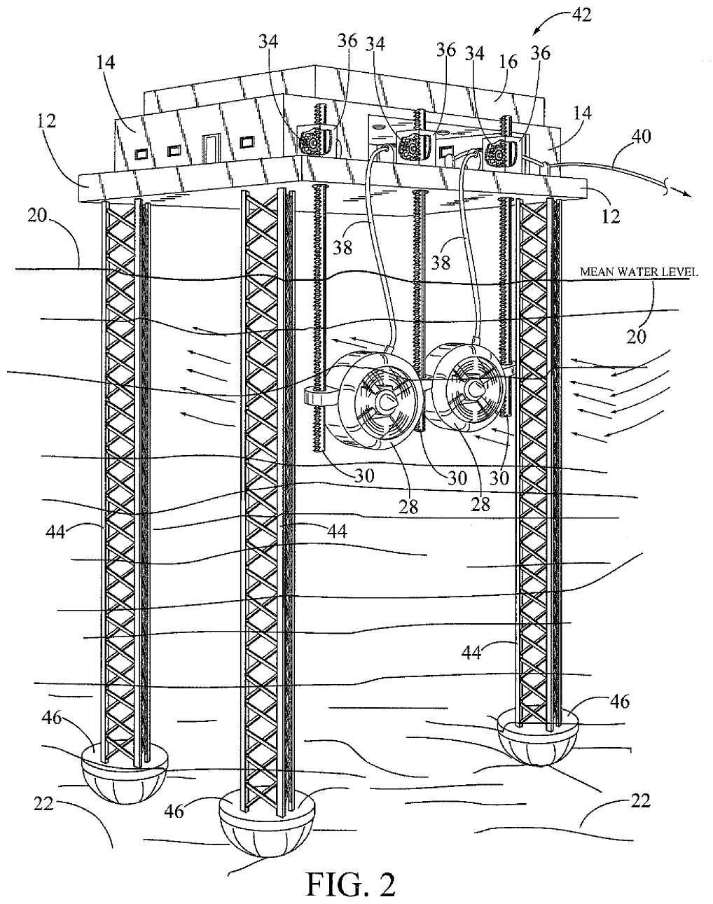

In FIG. 2, a perspective view of a decommissioned jack up oil drilling rig is shown and having general reference 42. The drilling rig 42, similar to the above mentioned semi-submersible drilling rig 10, also includes an operating platform deck 12, a maintenance shop 14, and platform offices 16. The offices 16 can include a control room, a dining hall, living quarters, and the like. The drilling rig equipment, used for offshore oil well drilling, has been removed from the deck 12.

Extending downwardly from the sides of the deck 12 are three jack up legs 44 for holding the deck above the mean water level 20. Typically, the jack up legs 44 extend below the water level 20, a distance in a range of 500 to 600 feet. The legs are anchored, for stability, to the ocean floor 22 using dish-shaped steel pads 46 placed on the ocean floor 22. While three jack up legs 44 are shown in the drawings, any number of legs can be used to provide stability to the deck 12.

In this drawing and similar to FIG. 1, a pair of hydro-kinetic turbines 28 are shown suspended into the ocean vertically and attached to three pinion gear racks 30. The turbines 28, which include electric generators, not shown in the drawings, are positioned to face the incoming ocean current, shown as arrows 32. Mounted on the deck 12 are three pinion gears 34 disposed inside gear housings 36. The gears 34 are used to raise and lower the gear racks 30 and the attached turbines 28 in the ocean current 32 to obtain a maximum current flow for generating electricity. The electric current is sent, via electric cables 38, to the deck 12. The electricity is than transferred to an electric land transmission cable 40, which extends to a nearby ocean shore and then to an electrical power grid system.

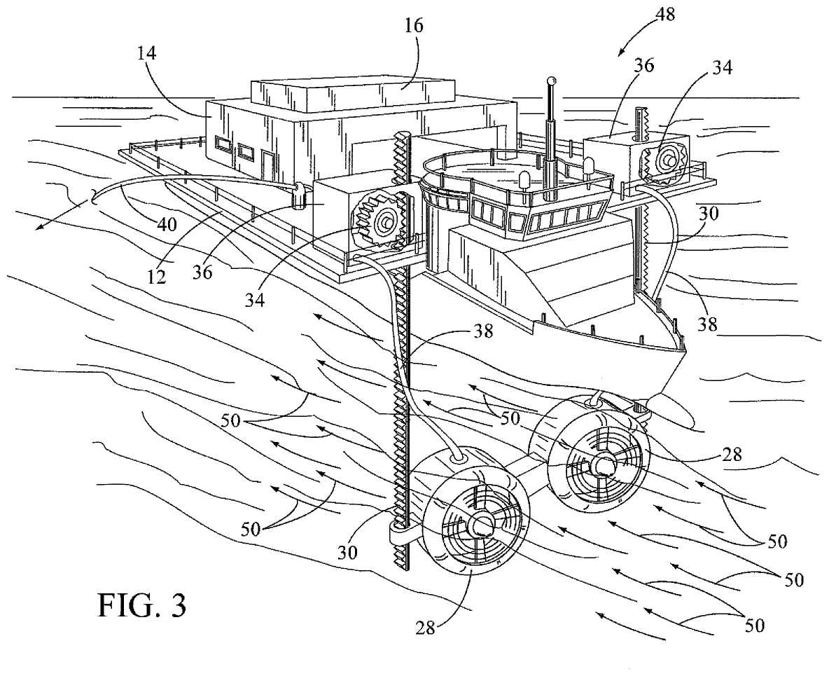

In FIG. 3, a perspective view of an ocean going boat is shown and having general reference numeral 48. In this illustration, the boat 48 has been modified, similar to the semi-submersible drilling rig 10 and the jack up drilling rig 42, to include an operating platform deck 12, a maintenance shop 14, and platform offices 16.

In this drawing and similar to FIGS. 1 and 2, a pair of hydro-kinetic turbines 28 are shown suspended into a river current, shown as arrows 50, and attached to two pinion gear racks 30. The turbines 28, which include electric generators, not shown in the drawings, are positioned to face the incoming liver current 50. Mounted on the deck 12 are two pinion gears 34 disposed inside gear housings 36. The gears 34 are used to raise and lower the gear racks 30 and the attached turbines 28 in the river current 50 to obtain a maximum current flow for generating electricity. The electric current is sent, via electric cables 38, to the deck 12. The electricity is than transferred to an electric land transmission cable 40, which extends to a nearby river shore and then to an electrical power grid system.

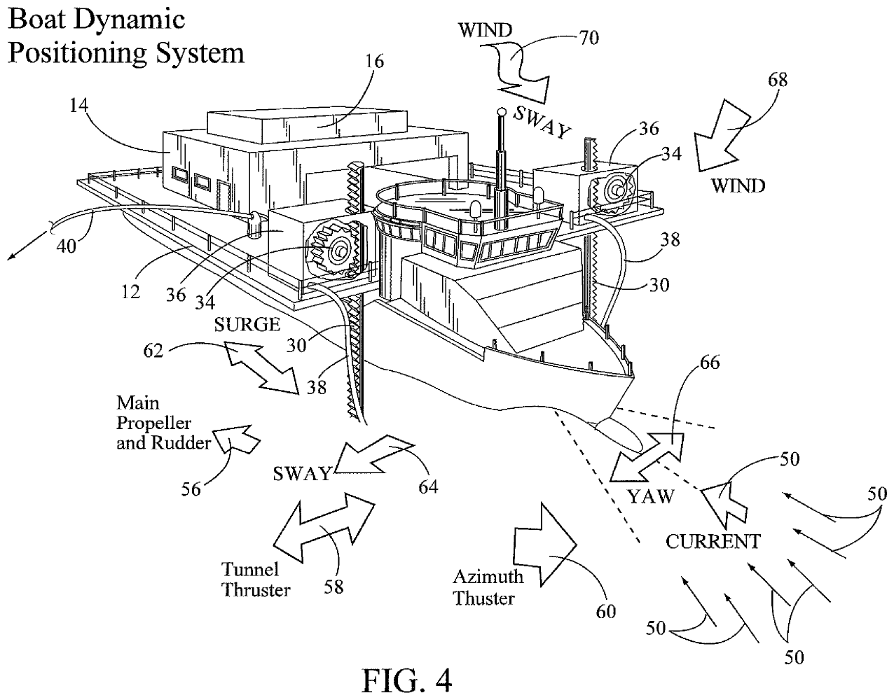

In FIG. 4, a perspective view of the ocean going boat 48, shown in FIG. 3, is illustrated having a dynamic positioning system, having a general reference numeral 52, for keeping the boat 48 and the hydro-kinetic turbines 28 oriented with the flow of the river current 50. The dynamic positioning system 52 is required because the boat 48 does not provide a stabile platform deck 12, when compared to the converted drilling rigs 10 and 42, shown in FIGS. 1 and 2. The system 52 includes a main propeller and rudder 56, a tunnel thruster 58, and a azimuth thruster 60 to compensate for river surge 62, river sway 64, yaw 66, wind 68 and wind and sway 70, shown as arrows in this drawing.

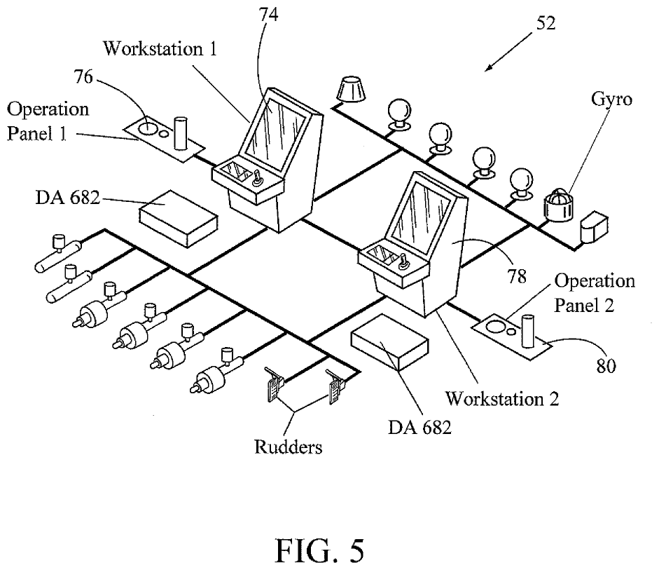

In FIG. 5, a perspective view of a control system 72, which is a computer controlled system, is used to automatically maintain a boat's position and heading with position reference sensors, combined with wind and motion sensors, and gyrocompasses. This system provides information to the computer pertaining to the boat's position and the magnitude and direction of environmental forces affecting its position. The control system 72 is used for operating the dynamic positioning system 52, shown in FIG. 4. The control station 72 includes a first workstation 74, with operation panel 76, and a second workstation 78, with operation panel 80.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

1. A mobile offshore electric power system used for generating electricity from an ocean current, the power system including:
a platform deck from a decommissioned oil drilling rig;
at least one hydro-kinetic turbine, with electric generator, suspended in the ocean current from the platform deck, and below an ocean mean water level:
one end of an electric generator cable connected to the electric generator, an opposite end of the generator cable attached to the platform deck; and
one of end of an onshore electric cable connected to the opposite end of the generator cable, and an opposite end of the onshore electric cable adapted for attachment to an onshore power grid.

2. The power system as described in claim 1 wherein the platform deck is from a converted semi-submersible decommissioned drilling rig, the drilling rig anchored to an ocean floor.

3. The power system as described in claim 1 wherein the platform deck is from jack-up decommissioned drilling rig, the drilling rig anchored to an ocean floor.

4. The power system as described in claim 1 further including means for raising and lowering the hydro-kinetic turbine in the ocean current and above and below an ocean mean level, the means for raising and lowering the turbine mounted on the platform deck.

5. The power system as described in claim 4 wherein the means for raising and lowering the hydro-kinetic turbine is a rack and pinion gear system mounted on the platform deck and attached to the turbine.

6. The power system as described in claim 5 further including a pair of hydro-kinetic turbines, with electric generators, connected to the rack and pinion gear system, the rack and gear system used for raising and lowering the turbines in the ocean current and above and below an ocean mean level.

7. A mobile offshore electric power system used for generating electricity from an ocean current, the power system including:
a platform deck from a decommissioned semi-submersible oil drilling rig and anchored to an ocean floor;
at least one hydro-kinetic turbine, with electric generator, suspended in the ocean current from the platform deck and below an ocean mean water level:
one end of an electric generator cable connected to the electric generator, an opposite end of the generator cable attached to the platform deck; and
one of end of an onshore electric cable connected to the opposite end of the generator cable, and an opposite end of the onshore electric cable adapted for attachment to an onshore power grid.

8. The power system as described in claim 7 further including means for raising and lowering the hydro-kinetic turbine in the ocean current and below an ocean mean water level, the means for raising and lowering the turbine mounted on the platform deck.

9. The power system as described in claim 8 wherein the means for raising and lowering the hydro-kinetic turbine is a rack and pinion gear system mounted on the platform deck and attached to the turbine.

10. The power system as described in claim 9 further including a pair of hydro-kinetic turbines, with electric generators, connected to the rack and pinion gear system, the rack and gear system used for raising and lowering the turbines in the ocean current and above and below an ocean mean water level.

11. The power system as described in claim 7 wherein the platform deck is mounted on a plurality of vertical buoyant columns, the columns disposed above and below a mean water line.

12. The power system as described in claim 11 wherein each of the buoyant columns are attached to one end of a mooring line, an opposite end of the mooring line attached to a suction pylon, the suction pylon adapted for anchoring the buoyant column to an ocean floor.

13. The power system as described in claim 12 wherein the mooring lines are anchor chains or anchor ropes.

14. A mobile offshore electric power system used for generating electricity from an ocean current, the power system including:
a platform deck from a decommissioned jack-up oil drilling rig and anchored to an ocean floor;
at least one hydro-kinetic turbine, with electric generator, suspended in the ocean current from the platform deck and below an ocean mean level:
one end of an electric generator cable connected to the electric generator, an opposite end of the generator cable attached to the platform deck; and
one of end of an onshore electric cable connected to the opposite end of the generator cable, and an opposite end of the onshore electric cable adapted for attachment to an onshore power grid.

15. The power system as described in claim 14 further including means for raising and lowering the hydro-kinetic turbine in the ocean current and above and below an ocean mean level, the means for raising and lowering the turbine mounted on the platform deck.

16. The power system as described in claim 15 wherein the means for raising and lowering the hydro-kinetic turbine is a rack and pinion gear system mounted on the platform deck and attached to the turbine.

17. The power system as described in claim 14 further including a pair of hydro-kinetic turbines, with electric generators, connected to the rack and pinion gear system, the rack and gear system used for raising and lowering the turbines in the ocean current and above and below an ocean mean level.

18. The power system as described in claim 14 wherein the platform deck is mounted on top of a plurality of vertical jack-up legs, the jack-up legs disposed above and below a mean water line.

19. The power system as described in claim 18 wherein a bottom of the jack-up legs are mounted on metal pads received on the ocean floor and adapted for anchoring the jack-up legs on the ocean floor.

20. The power system as described in claim 18 wherein the jack-up legs have a length in a range of 400 to 600 feet.
